(19) United States
(12) Patent Application Publication
(10) Pub. No.: US 2024/0198336 A1
(43) Pub. Date: Jun. 20, 2024

(54) CAPILLARY PARTITIONING MICROFLUIDICS

(71) Applicant: Anchorline Biolabs, Inc., Dover, DE (US)

(72) Inventors: Dianna Maar, Mountain House, CA (US); Nicholas Heredia, Mountain House, CA (US); Clinton L. Torres, Dublin, CA (US)

(21) Appl. No.: 18/540,754

(22) Filed: Dec. 14, 2023

Related U.S. Application Data
(60) Provisional application No. 63/476,104, filed on Dec. 19, 2022.

(51) Int. Cl. B01L 3/00

(52) U.S. Cl. CPC B01L 3/502761; B01L 2200/0647; B01L 2300/0832; B01L 2300/12

(57) ABSTRACT

Provided herein are microfluidic devices, and related processes for making and methods of using, wherein the devices include tubes with partitioned hydrophilic and hydrophobic fluids.

### CROSS-REFERENCE

The present application is a U.S. non-provisional filing under 35 U.S.C. § 111(a), which claims the benefit of U.S. Provisional Patent Application No. 63/476,104 (filed on Dec. 19, 2022), which is incorporated herein by reference in its entirety.

### FIELD

The present disclosure concerns microfluidics, methods of using microfluidics, and processes for making microfluidics and components thereof.

### BACKGROUND

Microfluidic devices contain and manipulate small volumes of fluids for analytical purposes. The benefit of using a microfluidic is the reduction in the volume of expensive reagents and device fluids which are needed for analysis. Unfortunately, the cost of manufacturing a microfluidic often exceeds the savings generated by the reduced fluid volumes savings.

Microfluidic devices, and microfluidic partitioning devices, allow for the analysis of small-sized reactions (e.g., sub-milliliter sizes). Microfluidic devices allow for faster reaction times, more sensitive detection or resolution, improved precision, and the ability to run multiple reactions on the same sample simultaneously as compared to conventional large-volume assays. Because they are smaller than most table-top analytical equipment, microfluidic devices allow for an increased number of replicates per sample (e.g., up to hundreds or thousands per test), which greatly increases the precision of measurements.

Manufacturing microfluidics is challenging and expensive. The cost of manufacturing and using microfluidics includes expensive hardware and reagents. The materials compatible for use with microfluidics, as well as the reagents used in them such as enzymes, are limited. The material options depend on porosity, chemical reactivity, inertness, pliability, and other properties such as viscosity and reactivity of the interfacing fluids; all of which must be fine-tuned to manufacture a commercially viable microfluidic. Reagents may be sensitive to, and reactive with, the chemical makeup of the device, the micro-scale nature of the channels, valves, and related components and microfluidic architecture. Microfluidics also require intricate architectures, precision fabrication tools, and bonding processes for layered constructions.

For example, for many chemical and biological reactions, the reagents are expensive and difficult to reliably resource. Reagents, such as enzymes, are one such example. In view of this, there is a need to reduce the amount and volume of reagents which are used in a microfluidic. There is a need in the relevant field for microfluidics with fluid-partitioning which enables the use of reduced sample volume, and still maintains sufficient or, in some cases, improved signal-to-noise for reaction readouts. For example, there is a need for a microfluidic with partitioning of a sample, which could create partitions of the sample that contain either no analyte, or one or more analytes.

Set forth herein are solutions to the aforementioned challenges as well as other problems known in the field to which the instant invention pertains.

The following documents may provide background information: U.S. patent and patent application Publication Nos. U.S. Pat. Nos. 9,089,844; 9,126,160; 9,216,392; 9,347,057; 9,500,664; 9,636,682; 9,492,797; 9,156,010; 8,633,015; 9,194,861; 9,422,586; 9,417,190; 7,041,481; 5,455,175 A; U.S. Pat. Nos. 7,993,934; 8,722,421; 10,378,049; 9,845,499 B2; U.S. Pat. Nos. 6,601,613; 8,911,683; 9,771,553; 9,795,697; 7,718,421 B2 (Roche Molecular Systems); U.S. Pat. No. 11,041,193 B2; also U.S. patent application Publication Nos. US 2021/0291187; US 2016/0199832 (Biofire Diagnostics); US 2006/0233671 A1; US 2021/0114029; and US 2005/0036918; also European Patent Application EP 3774005 A1; and see also Madhusudan B Kulkarni and Sanket Goel 2020 Eng. Res. Express 2 042001; M. Sbragaglia et al; “Sliding drops across alternating hydrophobic and hydrophilic stripes”; Phys Rev E Nonlin Soft Matter Phys. 2014 January; 89(1); Z. Long et al.; “Fundamentals of magnet-actuated droplet manipulation on an open hydrophobic surface”; Lab Chip 2009 Jun. 7; 9(11): 1567-75; M. Choi et al; “Hydrophilic strips for preventing air bubble formation in a microfluidic chamber”; Electrophoresis 2015 December; 36(23): 2896-901; G. Parikesit et al; “Observation of hydrophobic-like behavior in geometrically patterned hydrophilic microchannels”; Biomicrofluidics 2010 Oct. 8; 4(4):44103. See also Biofire cartridge, and Roche, LIAT.

### SUMMARY

In one embodiment, set forth herein is a device that includes at least one tube comprising a hydrophilic fluid and a hydrophobic fluid; wherein the hydrophilic fluid and the hydrophobic fluid are partitioned within the at least one tube forming partitions.

In a second embodiment, set forth herein is a process for making a partition in a tube, including the following steps in the following order: a) providing a tube; b) filling the tube with a hydrophobic solution; and c) filling the tube with a hydrophilic solution.

In a third embodiment, set forth herein is a method of using a device, herein, including performing a reaction in the tube wherein the reactions are selected from the group consisting of chemical, biological, biochemical, microbiological, immunological, or combinations thereof.

In a fourth embodiment, set forth herein is a method of using a device, herein, including thermal cycling a device.

In a fifth embodiment, set forth herein is a method of using a device, herein, including recovering the hydrophobic fluid for secondary uses.

In a sixth embodiment, set forth herein is a method of using a device, herein, including moving beads through the partitions.

### BRIEF DESCRIPTIONS OF THE DRAWINGS

FIG. 1 shows a process for partitioning fluids within the tubing of a microfluidic, in one embodiment herein.

FIG. 2 shows a microfluidic with five fluid-partitioned tubes, in one embodiment herein.

FIG. 3 shows an embodiment for fast thermal-cycling, in one embodiment herein.

FIG. 4 shows an embodiment for fast thermal-cycling, in one embodiment herein.

FIG. 5 shows an embodiment for fast thermal-cycling, in one embodiment herein.

FIG. 6 shows an embodiment for fast thermal-cycling, in one embodiment herein.

FIG. 7 shows a series of eight tubes with partitions formed therein according to Example 1, herein.

FIG. 8 shows a drinking straw having a diameter of 4 mm with partitions formed therein according to Example 1, herein.

FIG. 9 shows a drinking straw having a diameter of 6 mm with partitions formed therein according to Example 1, herein.

FIG. 10 shows a diagram of a linear arrayed tube, which is similar to that in FIGS. 11 and 12, thermo-cycles with a system that uses different temperature air (BioOven).

FIG. 11 shows a picture of a linear tube array post thermal-cycling. This image shows 30 linear arrayed 254 micron inner-diameter tubing having partitions with the positive PCR reaction (white), negative PCR reactions (light grey), and avocado oil separation fluid (darker grey between partitions). This image was of the COVID-19 N1 assay on N1 plasmid control material. The N1 FAM assay (2019-nCOV RUO Kit CAT #10006713 IDT) and N1 control plasmid (2019-nCOV_N Positive Control CAT #10006625 from IDT) shown here was used to generate comparable data to an on-market-digital PCR system (see FIG. 12). Partitions were formed by filling the tubes with Avocado oil at −20 inches Hg vacuum followed by the PCR reaction (ddPCR Supermix for Probes). The loading was performed at room temperature (22° C.) at −20 inches Hg vacuum and then thermal cycled with one 10-minute Hotstart cycle at 95° C. for 3 minutes and 40 cycles at 92° C. for 25 seconds and 58° C. for 40 seconds on a BioTherm BioOven III.

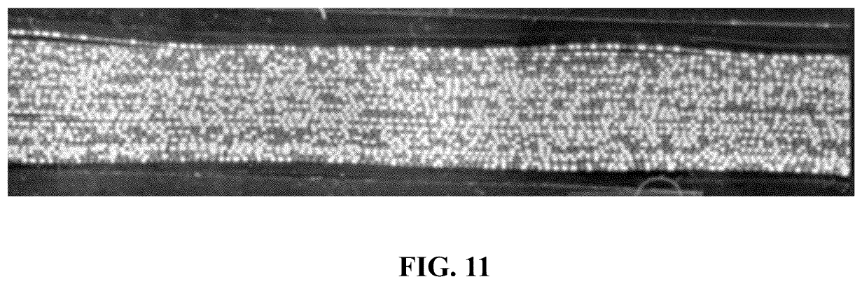

FIG. 12 shows COVID-19, N1, FAM assay data compared to the on-market-digital PCR system, QX100.

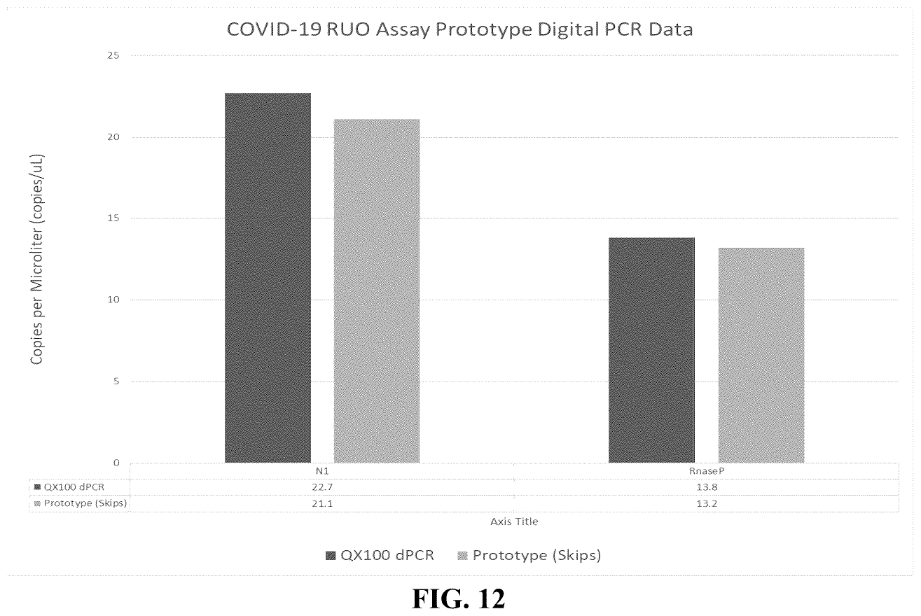

### DETAILED DESCRIPTION

Set forth herein are novel microfluidic devices and related methods and processes which overcome problems in the relevant field to which this disclosure pertains. The microfluidic devices are easy to manufacture and are compatible with a wide range of reagents. This new system can be configured to create many different types of reactions. Disclosed herein is a method that can obtain these benefits while reducing costs and manufacturing challenges.

The disclosure herein sets forth microfluidics that use small-diameter tubing to partition reactions for further analysis. The tubing is commercially available, highly precise, and prefabricated (Scientific Commodities Inc. cat number Cat. #BB311-32, another example VWR Master Flex Ultramicrobore cat number MFLX06417-76). This overcomes the challenges and expense of manufacturing specialized microfluidic devices. The disclosure herein sets forth microbiological reaction devices that can be manufactured at scale. The tubing is useful for creating single or multiple-partitioned reactions within the tubing. These partitions are made using two or more liquids with varying viscosities and hydrodynamic properties. In some examples, the two fluids are immiscible with each other.

The disclosure herein includes devices for small bulk reactions, in which the tubing can be filled with the reaction, sealed, reacted via time and or temperature, and read via fluorescence, pH, colorimetric development, chemiluminescence, electroluminescence among other methodologies for signal detection. The disclosure herein includes devices for partitioned analysis, as further described below.

The disclosure herein relates to tubes having partitions that are formed without the use of valves. The number of partitions in each tube is greater than what is found by the phase separation of two fluids into two partitions in an open container. In some embodiments, the length of the tubes used to contain these partitions is many times (e.g., 1, 2, 3, or 10 times greater) than the diameter of the tube. For example, in some embodiments, the length of the tubes used to contain these partitions is 10 times greater than the diameter of the tube. For example, in some embodiments, the length of the tubes used to contain these partitions is 1,000 times greater than the diameter of the tube. For example, in some embodiments, the length of the tubes used to contain these partitions is 10,000 times greater than the diameter of the tube. In some embodiments, the partitions are useful in microfluidic devices. In some embodiments, the partitions protect from cross contamination.

### Definitions

As used herein, the term “barcode” refers to the physical location in the linear tubing. The partitions can be located by imaging to determine a partition of interest. Because the partitions are static (non-moving) they can be excised from the tubing or alternatively pushed or pulled through the tubing to a collection point/junction.

As used herein, the term “microfluidic” refers to a device or component of a device that controls the behavior of fluids with a constrained volume. The microfluidic device manipulates fluids that are geometrically constrained to a small scale (typically sub-millimeter) at which surface forces dominate volumetric forces.

As used herein, the term “hydrophobic fluid” refers to a solution that repels water.

As used herein, the term “hydrophilic fluid” refers to a solution that attracts or is miscible with water.

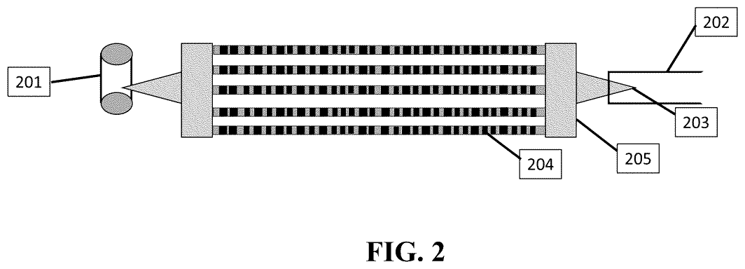

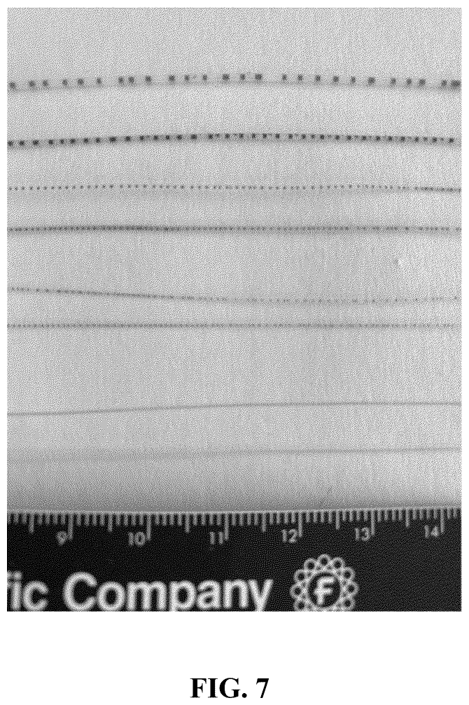

As used herein, the term “partitions” refers to the segments within a tube that is filled with at least one hydrophobic fluid and one hydrophilic fluid. Partitions are shown in FIG. 7. Partitions are also illustrated in FIG. 2. Partitions may be referred equivalently herein as skips.

As used herein, the term “tube geometry” refers to the shape of the inner lumen of a tube.

As used herein, the term “stable fluid-fluid interface” refers to the surface of contact between one hydrophobic fluid and one hydrophilic fluid, when both are inside a tube. The surface of contact is stable over temperatures. For example, the fluid-fluid interface may be stable to up to 200° C. and down to 0° C. The surface of contact is stable over time. For example, the fluid-fluid interface may be stable for hours, days, weeks, months, or years. The surface of contact is stable over reactions. For example, the fluid-fluid interface may be stable even when a PCR reaction occurs in one or more partitions. The surface of contact if the tubes are cut. For example, the fluid-fluid interface may be stable within portions of tube which are cut from a larger tube segment. The surface of contact can be made stable by using fixing reagents such as gelling agents (e.g., agarose, polyacrylamide, gelatin, poloxamers such as F68 and F127). The stable fluid-fluid interface results from the equilibrium between available capillary surface area of one fluid and the available capillary surface area of another fluid.

### Devices

In some embodiments, set forth herein is a device, comprising at least one tube comprising a hydrophilic fluid and a hydrophobic fluid; wherein the hydrophilic fluid and a hydrophobic fluid are partitioned within the at least one tube forming partitions.

In some examples, the number of tubes may vary. In some examples, the device includes short tubes and long tubes. In some examples, the device includes 1-50,000 tubes per reaction.

FIG. 2 shows an embodiment of a device with tubes having partitions. The partitions are labeled as 204. The oil and sample well are attached to an inlet that leads into the tubes and is labeled as 201. A vacuum line is shown attached to the outlet end of the device and is labeled as 202. The exit or waste port leading from the tubes into the vacuum line is labeled as 203. The tubing and partitions are labeled as 204 and 205. Also shown is a fluidic connection leading to the 5 tubes. In some embodiments, there would be one reaction/sample spread across multiple tubes.

In some embodiments, set forth herein is a device comprising: at least one tube comprising a hydrophilic fluid and a hydrophobic fluid; wherein the hydrophilic fluid and the hydrophobic fluid are partitioned within the at least one tube forming partitions.

In some embodiments, including any of the foregoing, the device includes 1 to 100 tubes.

In some embodiments, including any of the foregoing, the device includes 30 tubes.

In some embodiments, including any of the foregoing, the partitions are regularly spaced.

In some embodiments, including any of the foregoing, the partitions are irregularly spaced.

In some embodiments, including any of the foregoing, the inside of the at least one tube is not coated with a surface coating agent.

In some embodiments, including any of the foregoing, the inside of the at least one tube is a continuous hydrophobic surface.

In some embodiments, including any of the foregoing, the device includes 5 to 500,000 partitions per length of tube.

In some embodiments, including any of the foregoing, the device includes 3,000 to 5,000 partitions per length of tube.

In some embodiments, including any of the foregoing, the device includes 200 partitions per length of tube.

In some embodiments, including any of the foregoing, the length of tube is 1 cm to 1000 m.

In some embodiments, including any of the foregoing, the length of tube is 0.5 mm to 10 mm.

In some embodiments, including any of the foregoing, the length of tube is 0.5 mm to 1 mm.

In some embodiments, including any of the foregoing, the length of tube is 5 cm to 10 cm.

In some embodiments, including any of the foregoing, the length of tube is 0.25 cm to 10 m.

In some embodiments, including any of the foregoing, the length of tube is 1 cm, 25 cm, 750 cm, or 1 m.

In some embodiments, including any of the foregoing, the at least one tube length is 2 m.

In some embodiments, including any of the foregoing, the device includes 200 partitions and wherein the length of tube is 25 cm.

In some embodiments, including any of the foregoing, the device includes 50 partitions and wherein the length of tube is 1 cm.

In some embodiments, including any of the foregoing, the device includes 4 partitions and wherein the length of tube is 1 cm.

In some embodiments, including any of the foregoing, the at least one tube inner diameter is 5 μm to 30,000 μm.

In some embodiments, including any of the foregoing, the at least one tube inner diameter is 10 μm to 10,000 μm.

In some embodiments, including any of the foregoing, the at least one tube inner diameter is 50 μm to 15,000 μm.

In some embodiments, including any of the foregoing, the at least one tube inner diameter is 50 μm to 500 μm.

In some embodiments, including any of the foregoing, the at least one tube inner diameter is 4 mm to 5 mm.

In some embodiments, including any of the foregoing, the at least one tube has an inner diameter of 50 μm.

In some embodiments, including any of the foregoing, the at least one tube has an inner diameter of 200 μm.

In some embodiments, including any of the foregoing, the embodiment includes combinations of tubes of differing diameters.

In some embodiments, including any of the foregoing, the embodiment includes combinations of tubes of differing lengths.

In some embodiments, including any of the foregoing, the embodiment includes combinations of tubes of differing diameters and lengths.

In some embodiments, including any of the foregoing, which include combinations of tubes of differing diameters and/or lengths, the tubes are connected in parallel.

In some embodiments, including any of the foregoing, which include combinations of tubes of differing diameters and/or lengths, the tubes are connected in series.

In some embodiments, including any of the foregoing, the embodiment includes multiple tubing combinations in a single embodiment.

In some embodiments, including any of the foregoing, the tubes have different diameters. In some embodiments, tubes are connected in series and have one or more different inner diameters. In some other embodiments, tubes are connected in parallel and have one or more different inner diameters.

In some embodiments, the tubes include different partition sizes from the same sample by using tubes that are connected but which have varying inner diameters.

In some embodiments, including any of the foregoing, when tubes of varying inner diameters are used, such tubes connect to each other at a common diameter. For example, one tube might have an inlet and outlet diameter of 0.5 mm, and, in between the inlet and outlet, the tube has an inner diameter of 1 mm. In this example, another tube might have an inlet and outlet diameter of 0.5 mm, and, in between the inlet and outlet, this another tube has an inner diameter of 4 mm. In this example, these two tubes could be connected since they have a common inlet and outlet diameter of 0.5 mm despite having varied inner diameters in between the inlet and outline. Other dimensions and sizing combinations are contemplated herein.

In some embodiments, including any of the foregoing, the at least one tube has an inner diameter of 254 μm.

In some embodiments, including any of the foregoing, the at least one tube has an inner diameter of 560 μm.

The device of any one of claims 1-30, wherein the at least one tube is optically clear.

In some embodiments, including any of the foregoing, a portion of the at least one tube is transparent.

In some embodiments, including any of the foregoing, the at least one tube is transparent on top but not transparent on the bottom.

In some embodiments, including any of the foregoing, a portion of the at least one tube is transparent.

In some embodiments, including any of the foregoing, at least one tube is transparent to fluorescent light.

In some embodiments, including any of the foregoing, the at least one tube is transparent to detection light.

In some embodiments, including any of the foregoing, the at least one tube is transparent to light from a detector or sensor inside the at least one tube.

In some embodiments, including any of the foregoing, the at least one tube is transparent to emission spectra, excitation spectra, or both emission spectra and excitation spectra, which are useful for photonic detection, magnetic detection, or both photonic detection and magnetic detection.

In some embodiments, including any of the foregoing, the at least one tube is a waveguide.

In some embodiments, including any of the foregoing, the at least one tube is made of a material that produces frustrated total internal reflection.

In some embodiments, including any of the foregoing, the at least one tube is rolled up.

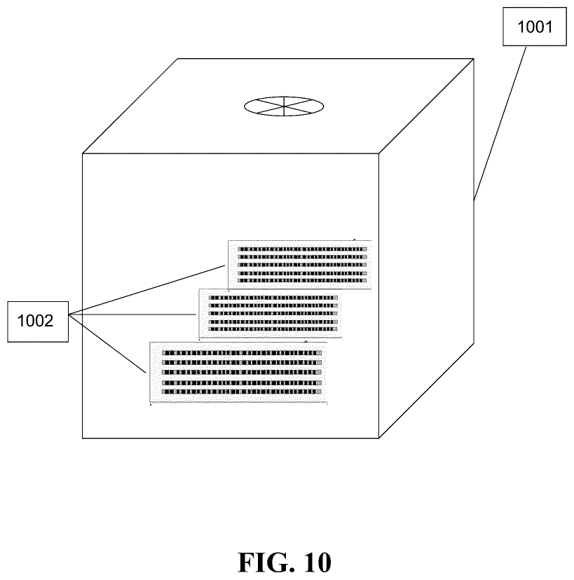

In some embodiments, including any of the foregoing, the at least one tube is linearly arrayed during viewing and/or thermal cycling. This means the tubes are laid flat. For example, see FIG. 10 herein.

In some embodiments, including any of the foregoing, the at least one tube is rolled up and has viewing length of 20 cm to 50 cm.

In some embodiments, including any of the foregoing, the at least one tube is rolled up and has a 25 cm viewing length.

In some embodiments, including any of the foregoing, the tube is rolled up and has the shape of a tape cassette.

In some embodiments, including any of the foregoing, the geometry of the at least one tube is selected from the group consisting of single lumen (bore), dual lumens, multi-lumens, circular-shaped lumens, oval-shaped lumens, square-shaped lumens, triangular-shaped lumens, polygonal-shaped lumens, and combinations thereof.

In some embodiments, including any of the foregoing, the tube volume ranges 100 picoliter (pL) to 1000 liters (L).

In some embodiments, including any of the foregoing, the tube volume ranges from 1 μL to 1 mL.

In some embodiments, including any of the foregoing, the partitions are formed by the hydrophobic solution coalescing in periodic nodes along the length of the tubing and separating segments of the hydrophilic fluid.

In some embodiments, including any of the foregoing, the partitions are formed by the hydrophobic solution coalescing at intermittent and/or periodic nodes along the length of the tubing and separating segments of the hydrophilic fluid.

In some embodiments, including any of the foregoing, the partitions are formed by the hydrophobic solution coalescing at irregularly-spaced nodes along the length of the tubing and separating segments of the hydrophilic fluid.

In some embodiments, including any of the foregoing, the partitions are formed by the hydrophobic solution and the hydrophilic fluid forming stable fluid-fluid interfaces.

In some embodiments, including any of the foregoing, the stable fluid-fluid interfaces are stable for at least 1 minute.

In some embodiments, including any of the foregoing, the stable fluid-fluid interfaces are stable for at least 150 minutes.

In some embodiments, including any of the foregoing, the stable fluid-fluid interfaces are stable for at least 48 hours.

In some embodiments, including any of the foregoing, the stable fluid-fluid interfaces are stable up to 120° C.

In some embodiments, including any of the foregoing, the stable fluid-fluid interfaces are stable down to 4° C.

In some embodiments, including any of the foregoing, the stable fluid-fluid interfaces are stable from −20° C. to −80° C.

In some embodiments, including any of the foregoing, the stable fluid-fluid interfaces are stable at 95° C.

In some embodiments, including any of the foregoing, the tubes are microfluidic-channels in a microfluidic chip.

In some embodiments, including any of the foregoing, the at least one tubes are made from a material selected from the group consisting of polytetrafluoroethylene (PTFE) plastic, glass, polyethylene, polystyrene, polypropylene, PDMS, vinyl, and combinations thereof.

In some embodiments, including any of the foregoing, the at least one tubes are made from polytetrafluoroethylene (PTFE).

In some embodiments, including any of the foregoing, the at least one tubes are made from low density polyethylene (LDPE).

In some embodiments, including any of the foregoing, the at least one tubes are made from Tygon-ND-100-80.

In some embodiments, including any of the foregoing, the hydrophobic fluid is selected from the group consisting of natural oil, plant-based oil, mineral oil, silicone oil, fluorinated oil, and combinations thereof.

In some embodiments, including any of the foregoing, the hydrophobic fluid is an oil

In some embodiments, including any of the foregoing, the hydrophobic fluid is a wax.

In some embodiments, including any of the foregoing, the hydrophobic fluid is a petroleum-based oil.

In some embodiments, including any of the foregoing, the hydrophobic fluid is a plant-based oils.

In some embodiments, including any of the foregoing, the plant-based oil is selected from avocado, olive, peanut, sunflower, sesame, corn, and combinations thereof.

In some embodiments, including any of the foregoing, the hydrophobic fluid is an animal-based oils.

In some embodiments, including any of the foregoing, the animal-based oil is selected from chicken oil, pork oil, beef oil, bison oil, lamb oil, turkey oil, fish oil, crustacean oil, or combinations thereof.

In some embodiments, including any of the foregoing, the animal-based oil is animal-derived fats.

In some embodiments, including any of the foregoing, the hydrophobic fluid is a petroleum oil.

In some embodiments, including any of the foregoing, the hydrophobic fluid is a silicon oil.

In some embodiments, including any of the foregoing, the hydrophobic fluid is a fluorinated oil.

In some embodiments, including any of the foregoing, the hydrophobic fluid is a combination of a hydrophobic fluid in any one of claims 61-72.

In some embodiments, including any of the foregoing, the hydrophobic fluid is a mixture of plant, animal, synthetic oils, or a combination thereof.

In some embodiments, including any of the foregoing, the hydrophobic fluid is selected from the group consisting of peanut, corn oil, canola oil, coconut oil, avocado oil, castor bean oil, olive oil soybean oil, bends of plant-derived oils, and combinations thereof.

In some embodiments, including any of the foregoing, the hydrophilic fluid is water.

In some embodiments, including any of the foregoing, the device includes magnetic beads or non-magnetic beads within the partitions.

In some embodiments, including any of the foregoing, the device includes magnetic beads or non-magnetic beads within the hydrophilic solution.

In some embodiments, including any of the foregoing, the device includes magnetic beads or non-magnetic beads within the hydrophobic solution.

In some embodiments, including any of the foregoing, the magnetic beads or non-magnetic beads are movable within the at least one tubes.

In some embodiments, including any of the foregoing, the magnetic beads or non-magnetic beads are fluorescent.

In some embodiments, including any of the foregoing, the magnetic beads or non-magnetic beads include a reaction mixture. For example, the reaction mixture may be the reagents used in an assay.

In some embodiments, including any of the foregoing, the partitions are a barcode.

In some embodiments, including any of the foregoing, the beads further comprise reagents or reactant molecules.

In some embodiments, including any of the foregoing, the beads further comprise nucleic acids, or proteins attached or encapsulated in the beads.

In some embodiments, including any of the foregoing, the beads are smaller than the lumen of the tubing.

In some embodiments, including any of the foregoing, the at least one tube is a circular lumen tube.

In some embodiments, including any of the foregoing, the device includes, in the at least one tubes, multiple or single microbial cells, plant cells, mammalian cells, virus particles, or combinations thereof.

In some embodiments, including any of the foregoing, the partitions separate the multiple or single microbial cells, plant cells, mammalian cells, or virus particles.

In some embodiments, including any of the foregoing, the surface tension of the at least one tubes range from 15 dynes/cm to 500 dynes/cm.

In some embodiments, including any of the foregoing, the surface tension of the at least one tubes is 33 dynes/cm to 35 dynes/cm.

In some embodiments, including any of the foregoing, the surface tension of the at least one tubes is 21 dynes/cm to 24 dynes/cm.

In some embodiments, including any of the foregoing, the surface tension of the at least one tubes is 30 dynes/cm to 31 dynes/cm.

In some embodiments, including any of the foregoing, the surface tension of the at least one tubes is 250 dynes/cm to 500 dynes/cm.

In some embodiments, including any of the foregoing, the at least one tube comprises gas bubbles.

In some embodiments, set forth herein is a device comprising at least two fluids which form a stable fluid-fluid interface within at least one tube; wherein the at least two fluids are partitioned within the at least one tube forming partitions.

In some embodiments, including any of the foregoing, the at least two fluids comprise an analyte solution and a non-analyte solution.

### Method of Making

For partitioning the reaction within the tubing, in some embodiments, the hydrophobic solution such as oil is added to the tubing first, followed by a hydrophilic solution, such as an aqueous solution, which is pulled or pushed through the oil filled tubing in a sequential manner. After the aqueous solution is pulled through the hydrophobic solution, partitions will spontaneously form. This partitioning effect is referred to as “skipping.” The partitions are herein referred to as “skips.” The physical positions of the skips are herein referred to as a “barcode”.

In some embodiments, the barcode is meaningful because of the positions of the skips. For example, one could extract information from the barcode such as positioning and sample identity.

In some embodiments, including any of the foregoing, in step 1, a tube would be filled with an oil or other hydrophobic solution or fluid. In some embodiments, the oil or other hydrophobic solution or fluid would fill at least one-third of the volume of the tube. In some embodiments, the tube would be filled under vacuum pressure to draw (i.e., oil pushed by the atmosphere) the oil or hydrophobic fluid into the tube. In other examples, the tube would be filled under positive pressure to push the oil or hydrophobic fluid into the tube. A mechanical pump would be used in some examples. A carrier fluid, such as helium gas, would be used in other examples. A carrier fluid, such as nitrogen gas, would be used in other examples. A carrier fluid, such as argon gas, would be used in other examples.

In some embodiments, including any of the foregoing, in step 2, the tube would be filled with an aqueous solution or other hydrophilic fluid. The aqueous solution or other hydrophilic fluid would partially displace the oil or other hydrophobic solution or fluid. In some examples, the tube would be filled with the fluids after step 2. In some embodiments, the tube would be filled under vacuum pressure to draw (i.e., aqueous solution pushed by the atmosphere) the aqueous solution or other hydrophilic fluid into the tube. In some embodiments, the tube would be filled under positive pressure to push the aqueous solution or other hydrophilic fluid into the tube. A mechanical pump would be used in some examples. A carrier fluid, such as helium gas, would be used in other examples.

In some embodiments, including any of the foregoing, in step 3, the partially displaced oil, or other hydrophobic solution or fluid, and the aqueous solution would partition into small, interspersed oil and hydrophobic segments. The tubes would be kept at a constant temperature during this partitioning process. In one example, the temperature would be room temperature.

In some embodiments, the benefits of this device include temperature control during loading and reading of the fluids. In some embodiments, the benefits of this device include retention of samples for later analysis. In some embodiments, it is possible to store and cut out positive partitions. In some embodiments, the benefits of this device include reusable tubing. In some embodiments, the benefits of this device include physical barcoding. In some embodiments, the device may be used with whole cell applications, or read partitions with cells before reacting. For example, the location within the tubing of the barcode could be static and could be used for isolating and processing specific partitions. In some examples, the barcodes are useful for tracking partitions. The barcodes may be used to send data show the data for parameters that affect partition size and speed of partitioning. The barcodes may be used to show the data for parameters that affect partition size and speed of partitioning.

In certain embodiments, including any of the foregoing, the size of these partitions or skips can be controlled through the viscosity of both the hydrophobic and aqueous solutions. See for example, Table 1 which shows the results of varying temperature on partition number. Table 1 shows how increasing temperature (and thus decreasing viscosity) increases the partitions per centimeter.

In certain embodiments, including any of the foregoing, the size of these partitions or skips can be controlled through the viscosity of both the hydrophobic and aqueous solutions, as well as the speed that the aqueous solution is pulled through the hydrophobic solution in the tube, and other controllable factors, such as temperature (i.e., Table 1). For example, the thicker the viscosity, the more oil is left on the surface of the bore of the tubing and so more oil remains on the walls of the bore to form partitions when displaced by the aqueous solution. Hence thicker viscosity leads to larger oil volume in between the skips. One having ordinary skill in the art would understand that surfactants would influence this dynamic.

In certain embodiments, including any of the foregoing, additional control over the partition size and spacing can be performed using common microfluidic partitioning devices, such as a microfluidic T-junction or a microfluidic Y-junction. When microfluidic partitioning devices are employed, multiple different fluids can be loaded, at controllable ratios, along the length of the tubes.

In certain embodiments, including any of the foregoing, the partitions form passively. Once the partitions, or skips, are created and the ends sealed, the partitions are stable within the tubing at high temperatures (e.g., 99° C.) and low temperatures (e.g., −20° C.). The stability of the skips is maintained without any specialized chemical surfactants or other hard to obtain or manufacture chemical compounds. Nonetheless, in some examples, surfactant and other chemicals may be beneficial for other purposes depending on the application and can easily be included or excluded from the partitioning. For example, Tween-80, fluorinated surfactants, ionic surfactants, non-ionic surfactants, zwitterionic surfactants, sodium dodecyl sulfate (SDS), non-ionic-surfactants, NP40(Nonidet), Tween-20, Triton X100, Zwitterionic-CHAPS, surfactants, may be used.

In certain embodiments, including any of the foregoing, a variety of hydrophilic and hydrophobic chemistries are stable along the tubing. For example, and without limitation, hydrophobic coconut oil, corn oil, or olive oil, may be used. For example, and without limitation, hydrophilic aqueous solutions with poloxamers from 0.01% to 50%, Aqueous solutions with glycerol from 0.01% to 50%, HEPES buffer, restriction enzyme buffers, reverse transcription buffers, cell lysis buffers, ligation buffers, in-vitro translation buffers, cell culture media, PCR reaction mix, Tris-HCL buffer, and gelatin may be used. See also Tables 1 and 2.

Table 1 shows the effect of the loading temperature, which is the temperature at which the hydrophobic solution is introduced into the tube. Table 1 shows that the partitions per centimeter of the tubing increases as a function of temperature. Experimental conditions were: −17 inHg (vacuum), TE buffer as Aqueous (DNA buffer), Avocado oil, 0.1% Red Dye, 0.5% non-Ionic Surfactant X v/v, 27.94 cm tube length, 254 μm diameter, PTFE tubing. Partition numbers were obtained visually by counting partitions within a centimeter long segment on the left end, right end, and middle portion of the tube length and then averaged.

TABLE 1

| Temperature | Partitions per Centimeter |
|---|---|
| (Celsius) | (Skips/cm) |
| 1 | 7.5 |
| 23.3 | 8.5 |
| 50.8 | 10.5 |

Table 2 shows the effect of tube length on partitions per centimeter. Partitions per centimeter are unaffected by several different tube lengths shown here.

Experimental conditions were: −17 inHg (vacuum), TE buffer as Aqueous (DNA buffer), Avocado oil, 0.1% Red Dye, 0.5% non-Ionic Surfactant X v/v, variable length tubes, 254 μm diameter, PTFE tubing, loaded at room temperature (22° C.). Partition numbers were obtained visually by counting partitions within a centimeter-long segment on the left end, right end, and middle portion of the tube length and then averaged.

TABLE 2

| Tube Length | Partitions per Centimeter |
|---|---|
| (centimeters) | (Skips/cm) |
| 7.6 | 8.5 |
| 15.2 | 8.5 |
| 30.5 | 8.5 |

In some embodiments, the skips disclosed herein maintain their volume, size, and position during heating, cooling, and reading of reaction signals. This allows for a large range of hydrophilic reactions (e.g., pH-based) to be created with inexpensive and easily obtained hydrophobic materials (e.g., natural plant-derived oils).

In certain embodiments, including any of the foregoing, set forth herein are methods for static reading which allows for resampling of fluorescent signatures and physical identification of each positive or negative reaction (partition).

In certain embodiments, including any of the foregoing, set forth herein are methods for cutting out, or alternatively, fluidically sorted downstream. The cut tubes could be retrieved so that any desired positive or negative partition could be collected for further analysis. This would allow for selective downstream processing and analysis of only those partitions with the fluorescent signal of interest. For example, single-cells could be physically cut out of the tubing or sorted fluidically. In some of these examples, the sorted tubes could be prepared for whole genome deep-sequencing. This allows for a cost-effective way to identify the insertion points of transduced DNA markers into the host-cell genome, or gene edits such as Crispr Cas9, as some example applications.

In some embodiments, real-time PCR-like imaging of the tubing is conducted for each partition. In some embodiments, this ability allows for relative measurements of DNA-copies per partition. In some embodiments, for single cell containing partitions, it would be possible to derive a relative measurement of copies per cell.

Measuring partition volume is difficult with droplets or microwells. Methods used for measuring droplet volumes are challenging. One challenge is that the droplets typically float around instead of remaining stationary on the same plane, especially with droplets made in fluorinated hydrocarbon, for example. Other methods used for measuring droplet size are to measure the droplets while they move past a detector or measure them in a glass slide chamber using microscopy. These methods are inaccurate, and thus increase the inaccuracy of the overall answers produced and typically result in the need to exclude droplets from the sample measurement. Microwells are also difficult as they can have varying fill levels that would be difficult to measure. This difficulty in measuring the partition volume results in less precise measurements and lost data points as well as dead-volume issues which lead to loss of sample being measured. The disclosure herein overcomes these challenges.

In contrast to droplet and microwell partitions, the partitions, herein, in some embodiments, are easier to measure. The tubing in the microfluidics disclosed herein have a known diameter which can be used to measure the volume of the reaction after viewing the length of tubing occupied by each partitioned reaction. This allows for each and every position, regardless of size, to be used by the system to calculate the measurement of the reaction. The precision and accuracy increase and the dead volume, or lost reaction volume, which is often associated with microfluidic devices is decreased or altogether eliminated.

Once formed, in some embodiments, the partitions are static even after many cycles of heating and cooling. The static partitions, or skips, allow for fluorescence of the partitions to be read and reread as many times as desired and stored for later analysis. Additionally, these skips can be retrieved from the tubing so that only the desired partition(s) are taken for subsequent reactions, manipulations, further analysis, or storage. The static positioning of the skips along the tubing automatically creates a physical barcode for that reaction. In the example of single-cell analysis, the retrieved partition of interest could be added to a well for Next Generation Sequencing library preparation. For example, the partition(s) of interest could be a single cell that was partitioned in the tubing and was identified as being positive for two DNA amplicons. Each of the double positive partitions could be cut out of the tubing and put into a new reaction well for deep sequencing preparation. This would be a significant cost savings as all the cells would need to be deep sequenced if the cells of interest could not be identified.

Tubing is readily available in a wide range of different diameters and different materials (i.e., plastics, glass, hybrid materials, etc.). The diameter and material properties of the tubing could be easily selected and sourced for each reaction type as needed, since there are many micro-tubing manufacturers globally.

In some embodiments, including any of the foregoing, the speed of partition formation depends on the speed at which the fluids are introduced into the tube.

In some embodiments, including any of the foregoing, the viscosity of the solutions affects the number of partitions formed. In some embodiments, the higher the viscosity, the more partitions formed.

### Thermal Cycling and Incubating Reactions

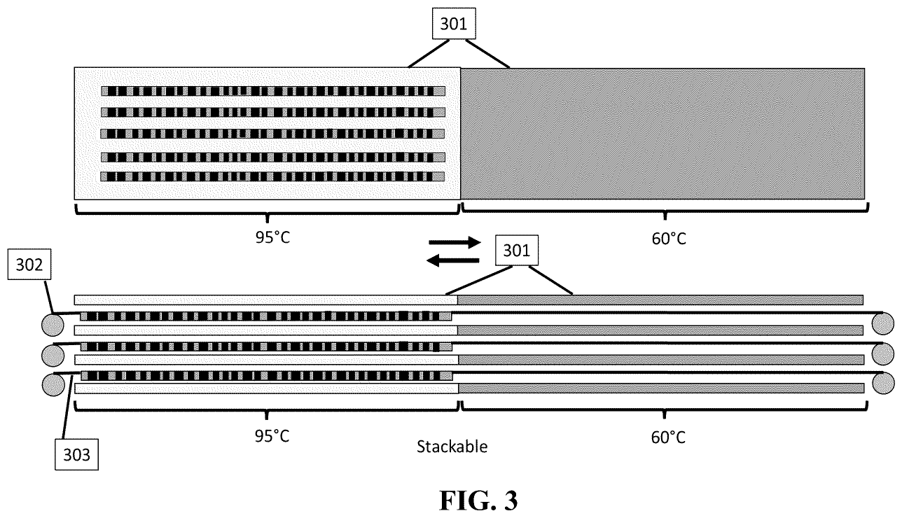

FIG. 3 shows an embodiment of a device, 301, with tubes having partitions and that is useful for fast thermal cycling. A series of rollers, 302, are shown which move tubes, 303, laterally back and forth. FIG. 3 shows a top view of device, 301, on the top. FIG. 3 shows a side view of device, 301, on the bottom. When the tubes are moved to the right, they are heated by a 60° C. hot plate. When the tubes are moved to the left, they are heated by a 95° C. hot plate. The tubes can be cycled left and right many times. Other temperatures can be achieved by tuning the hot plates. More than two hot plates are contemplated herein. Three, four, five, or more hot plates may be used, each at a different temperature. As shown in FIG. 3, the tubes can be positioned in layers which are stackable.

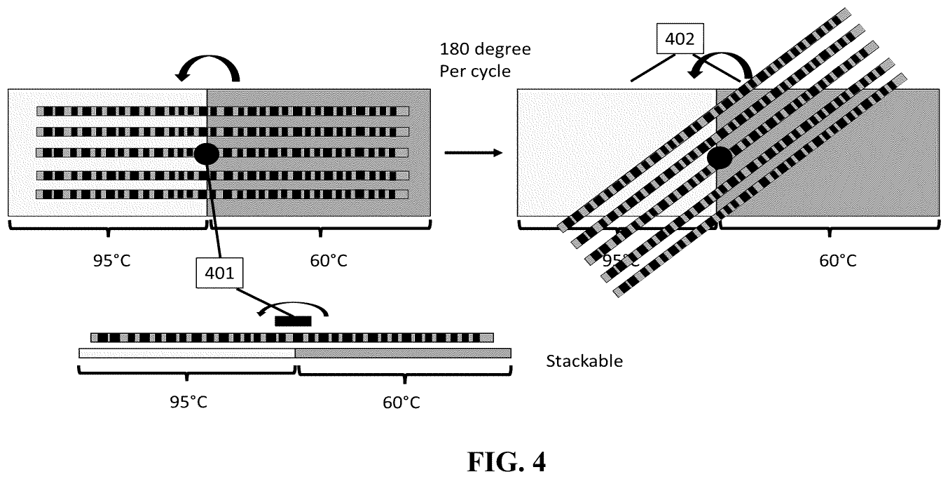

FIG. 4 shows an embodiment of a device, 402, with tubes having partitions and that is useful for fast thermal cycling. A central pivot, 401, is shown which rotates tubes from one hot plate to another hot plate. FIG. 4 shows a top view of device, 402, on the top. FIG. 4 shows a side view of device, 402, on the bottom. When the tubes are rotated 180°, as shown in the top portion of FIG. 4, they rotate between a 60° C. hot plate and a 95° C. hot plate. The tubes can be rotated this way many times. Other temperatures can be achieved by tuning the hot plates. More than two hot plates are contemplated herein. Three, four, five, or more hot plates may be used, each at a different temperature.

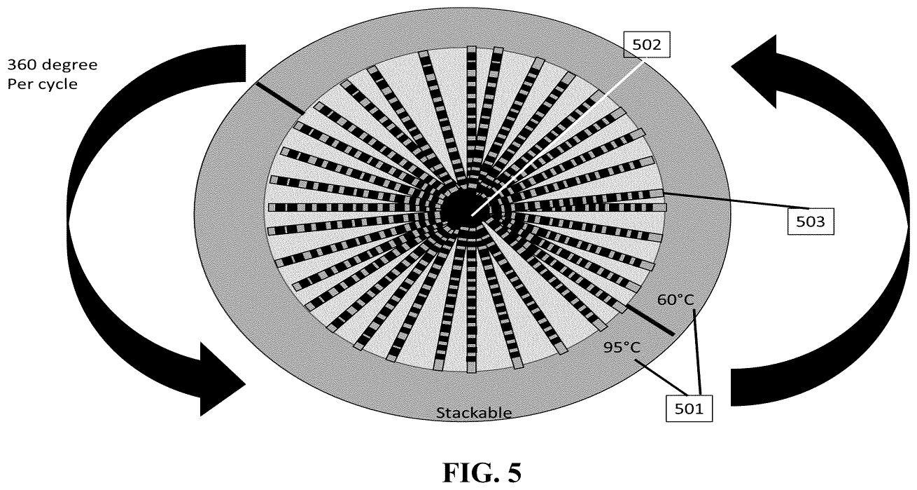

FIG. 5 shows an embodiment of a device, 502, with tubes having partitions and that is useful for fast thermal cycling. A central axle, 502, is shown around which tubes rotates from one hot position to another hot position. FIG. 5 shows a stackable configuration. When the tubes are rotated 360°, as shown in FIG. 5, they rotate between a 60° C. hot position and a 95° C. hot position. Other temperatures can be achieved by tuning the hot positions. More than two hot positions are contemplated herein. Three, four, five, or more hot positions may be used, each at a different temperature.

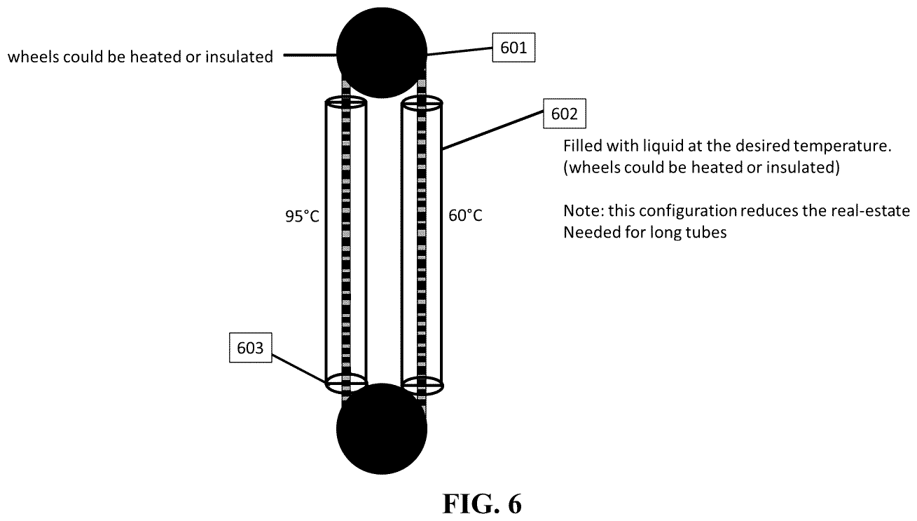

FIG. 6 shows an embodiment of a device with tubes having partitions and that is useful for fast thermal cycling. A pulley wheel, 601, is shown around which tubes are moved from one hot position to another hot position. The pulley wheel, 601, may be heated. When the tubes move around the pulley wheel, 601, as shown in FIG. 6, the tubes move from a 60° C. hot cylinder, filled with a fluid at a fixed temperature, to a 95° C. hot cylinder, filled with a fluid at a fixed temperature. The tubes can be moved this way many times. Other temperatures can be achieved by tuning the temperature of the fluids in the cylinders through which the tubes with partitions move. More than two hot cylinders are contemplated herein. Three, four, five, or more hot cylinders may be used, each at a different temperature.

In certain embodiments, including any of the foregoing, convective heated and cooled air can be used to thermal cycle or incubate the tubes.

In the relevant field to which the instant invention pertains, there is a problem related to the speed of thermal-cycling, which depends on the speed at which a device is heated (e.g., by ramping up) or cooled (e.g., by ramping up) in temperature. Cost of instrument is high. The devices described herein overcome these challenges.

In certain embodiments, including any of the foregoing, set forth herein, are methods of thermal-cycling a microfluidic device. In certain examples, the microfluidic tubes are moved between static temperature plates or temperature zones. This increases the speed of analysis by avoiding a slow ramp up in temperature which occurs when the entire device is heated.

In certain embodiments, including any of the foregoing, when thermal cycling the tubes, the ends of the tubes are fluidically sealed (closed) on both ends.

In certain embodiments, including any of the foregoing, when loading the oil, the sample input end is open to atmosphere, and the other end is connected to a vacuum source.

In certain embodiments, including any of the foregoing, when using pressure instead of vacuum, the oil and sample input end is under a pressure source, and the other end is open to atmosphere during loading.

In certain embodiments, including any of the foregoing, when loading the oil, the sample input end is coupled to a device or devices which allow for both positive pressure and vacuum to be used to load the tubes with a fluid.

### EXAMPLES

Unless specified otherwise, reagents and materials were commercially purchased.

### Example 1—Process of Making

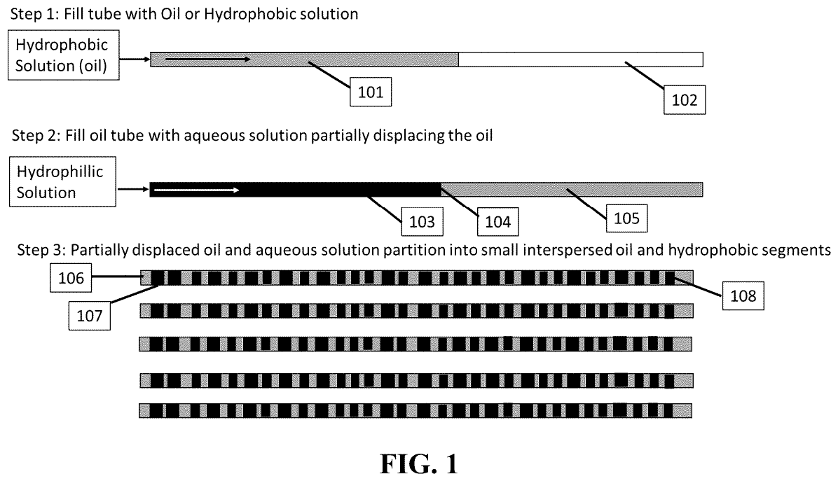

A partitioned tube was made according to the steps in FIG. 1.

In step 1, a series of tubes were filled with an oil. The oil filled at least one-third of the volume of each tube. The tubes were filled under vacuum pressure to draw (i.e., oil pushed by the atmosphere) the oil or hydrophobic fluid into the tube. A mechanical pump was used.

In step 2, the tubes were filled with an aqueous solution. The aqueous solution displaced the oil and filled the tubes after step 2. The tubes were filled under vacuum pressure to draw (i.e., oil pushed by the atmosphere) the oil or hydrophobic fluid into the tube. A mechanical pump was used.

In step 3, the partially displaced oil and the aqueous solution partitioned into small, interspersed oil and hydrophobic segments. See FIG. 7, which shows these partitions.

The tubes were kept at room temperature during this partitioning process.

In FIG. 7, starting from the top and going to the bottom, the inner diameters of the tubes in the picture are, in microns (μm):
PTFE: 559 μm;
PTFE: 457 μm;
PTFE: 254 μm;
Tygon ND-100-80: 254 μm;
PTFE: 203 μm;
LDPE: 203 μm;
LDPE: 127 μm; and
PTFE: 102 μm.

In FIG. 7, a standard metric ruler is shown in the bottom and displays centimeter markings.

In a comparative example, tubes were filled with the same above fluids but in the reverse order. When the aqueous solution was added first, the partitions shown in FIG. 7 did not form. The Applicant found surprisingly that the partitioning occurred when the oil was first added, followed by the aqueous fluid.

The Applicant found surprisingly that the order in which the component fluids were added to the tubing affected the formation of the partitions.

The Applicant found surprisingly that the partitions were stable over several months.

Stability is determined by visually counting the partitions over time and also by taking images, photographic and/or via laser imaging system (Typhoon 9410, GE Amersham Biosciences). Stability was observed using several methods. Two different dyes were used. Red oil-based dye and aqueous blue dye in water were partitioned in tubes, thermalcycled, and imaged using a laser scanner (Typhoon 9410) Thermal-cycling between 95° C. and 60° C. was tested in water baths heated with hot plates in Pyrex beakers, images were visually aligned, and partitions counted. 95° C. for 1 minute and 60° C. for 1 min for a total of 40 cycles back and forth.

Thermal-cycling of the partition-filled tubes occurred between 95 and 60° C. in water baths heated on hot plates in Pyrex beakers, using hot air blown across the tubes using a Bio oven PCR machine, or placed on a flat block thermal cycler (Applied Biosystems 9700 Gene Amp). Images were visually inspected over time (3 months) and partitions were counted and aligned. Mixing of the two-colored portions were not observed.

The Applicant in the instant case found, surprisingly, that the partitions were not disturbed or affected by thermal-cycling at very high temperatures (95° C. and 60° C.) for 2-3 hours. Commercial avocado cooking oil was used.

A variety of tube materials were tested. The Applicant found surprisingly that the partitions formed for a variety of tubes having a variety of tube inner diameters. This included drinking straw diameters and down to 100 μm diameter tubing. These tubes were made under vacuum. The solution was a PCR reaction mixture—Platinum Taq Hotstart PCR Master Mix from Life Technologies was used. Other commercially available PCR supermixes could also be used.

Both liquids, hydrophobic (avocado oil having 0.05% red dye), and hydrophilic (Tris EDTA pH 8 buffer) were pulled through the tubing using a vacuum pump at −20 in Hg. Reactions were set up this way at room temperature (22° C.).

The Applicant found surprisingly that the pressure and speed of the aqueous solution and oil moving through the tube have very little impact on the partition size or spacing.

The Applicant found surprisingly that the liquid remained in the tube even after the tube was cut.

### Example 2—Process of Making

A series of tubing material shown in the first column in Table 3 were tested. The inner diameter and outer diameter of each tube tested is shown in the second and third columns in Table 3. CR Master Mix from Life Technologies was used. The number of partitions per cm is shown in the fourth column in Table 3.

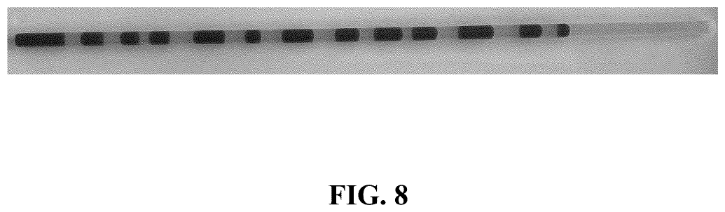

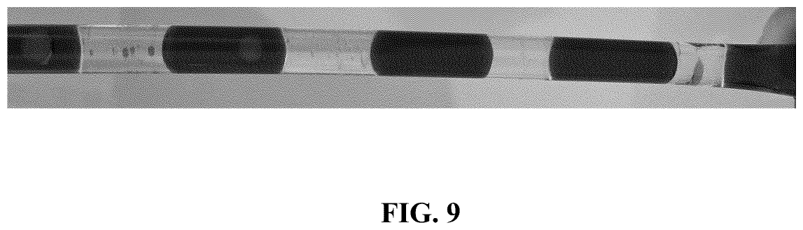

A series of PTFE tubes having varying inner and outer diameters, as shown in Table 4, were tested. The inner diameter and outer diameter of each tube tested is shown in the second and third columns in Table 4. The number of partitions per cm is shown in the fourth column in Table 4. See also FIGS. 7-9.

The tubes were made according to the steps in FIG. 1.

In step 1, a series of tubes were filled with an oil. The oil filled at least one-third of the volume of each tube. The tubes were filled under vacuum pressure to draw (i.e., oil pushed by the atmosphere) the oil or hydrophobic fluid into the tube. A mechanical pump was used.

In step 2, the tubes were filled with an aqueous solution. The aqueous solution displaced the oil and filled the tubes after step 2. The tubes were filled under vacuum pressure to draw (i.e., oil pushed by the atmosphere, Vacuum −20 inHg (inch mercury)) the oil or hydrophobic fluid into the tube. A mechanical pump was used.

Both liquids, hydrophobic (avocado oil having 0.05% red dye), and hydrophilic (Tris EDTA pH 8 buffer) were pulled through the tubing using a vacuum pump at −22 in Hg. Reactions were set up this way at room temperature (22° C.).

Tris-EDTA buffer solution pH 8.0 was used as this mimics a PCR reaction buffer.

In step 3, the partially displaced oil and the aqueous solution partitioned into small, interspersed oil and hydrophobic segments. See FIG. 7, which shows these partitions.

The tubes were kept at room temperature during this partitioning process.

TABLE 3

| | Inner | Outer | |
|---|---|---|---|
| Tubing | diameter | diameter | Partitions |
| material | microns | microns | per cm |
| PTFE | 559 | 1168 | 3.0 |
| PTFE | 457 | 914 | 5.3 |
| PTFE | 254 | 508 | 9.3 |
| Tygon | 254 | 762 | 11.6 |
| ND-100-80 | | | |
| PTFE | 203 | 406 | 11.6 |
| LDPE | 203 | 356 | 12.0 |
| LDPE | 127 | 254 | 14.0 |
| PTFE | 102 | 406 | 19.3 |
| PTFE | 50 | 356 | 30.0 |

TABLE 4

| | Inner | Outer | |
|---|---|---|---|
| Tubing | diameter | diameter | Partitions |
| material | microns | microns | per cm |
| PTFE | 559 | 1168 | 3.0 |
| PTFE | 457 | 914 | 5.3 |
| PTFE | 254 | 508 | 9.3 |
| PTFE | 203 | 406 | 11.6 |
| PTFE | 102 | 406 | 19.3 |
| PTFE | 50 | 356 | 30.0 |

### Example 3—Prophetic Process of Using

The device in Example 1 could be used to create partitions for physical analyte counting within each test sample or test partition. This would provide a yes or no signal on analyte detection and be an improvement over digital PCR.

The uses of this method would include PCR results in these partitions including the ability to detect and quantitate, with a high degree of precision and accuracy, the number of copies of nucleic acid analytes such as cancer mutations, SARS-COV-2 (COVID-19), viral vectors used for gene therapy delivery (i.e., rAAV), single cell lysis and amplification of gene targets, reverse transcription of RNA targets for quantification, isothermal amplification of mammalian, bacterial, and viral targets, single cell nucleic acid sequencing library preparation, protein-protein interactions and protein-nucleic acid interactions via proximity ligation reactions and most PCR. A specific example would be where one could perform digital PCR in an affordable system with affordable reagents that utilizes these new partitions. Utilizing partitions with this digital PCR, the ability to determine COVID-19 status by physically counting SARS-CoV-2 RNA would be improved. This physical counting of SARS-COV-2 RNA increases the accuracy, reproducibility and reliability of the test. By making this system faster and more affordable than other digital PCR systems, COVID-19 testing could become more commonly used in a variety of settings and locations. Additionally, the system described here would allow for more sample to be analyzed due to greatly reduced dead volume (i.e., rejected partitions seen with other digital PCR systems).

Stability would be determined by visually counting the partitions over time and also by taking images, photographic and/or via laser imaging system (Typhoon 9410, GE Amersham Biosciences)

The embodiments and examples described above are intended to be merely illustrative and non-limiting. Those skilled in the art will recognize or will be able to ascertain using no more than routine experimentation, numerous equivalents of specific compounds, materials, and procedures. All such equivalents are considered to be within the scope and are encompassed by the appended claims.

1. A device, comprising:
at least one tube comprising a hydrophilic fluid and a hydrophobic fluid;
wherein the hydrophilic fluid and the hydrophobic fluid are partitioned within the at least one tube forming partitions.

2. The device of claim 1, comprising 1 to 100 tubes.

3. (canceled)

4. The device of claim 1, wherein the partitions are regularly spaced.

5.-7. (canceled)

8. The device of claim 1, comprising from 5 to 500,000 partitions per length of tube.

9. (canceled)

10. The device of claim 8, comprising about 200 partitions per length of tube.

11.-13. (canceled)

14. The device of claim 8, where the length of tube is from 0.25 cm to 10 m.

15.-22. (canceled)

23. The device of claim 1, wherein the at least one tube inner diameter is from 50 μm to 500 μm.

24.-35. (canceled)

36. The device of claim 1, wherein the at least one tube is transparent to emission spectra, excitation spectra, or both emission spectra and excitation spectra, which are useful for photonic detection, magnetic detection, or both photonic detection and magnetic detection.

37.-43. (canceled)

44. The device of claim 1, wherein the geometry of the at least one tube is selected from the group consisting of single lumen (bore), dual lumens, multi-lumens, circular-shaped lumens, oval-shaped lumens, square-shaped lumens, triangular-shaped lumens, polygonal-shaped lumens, and combinations thereof.

45. (canceled)

46. (canceled)

47. The device of claim 1, wherein the tube volume ranges from 1 μL to 1 mL.

48. The device of claim 1, wherein the partitions are formed by the hydrophobic solution coalescing in periodic nodes along the length of the tubing and separating segments of the hydrophilic fluid.

49. (canceled)

50. (canceled)

51. The device of claim 1, wherein the partitions are formed by the hydrophobic solution and the hydrophilic fluid forming stable fluid-fluid interfaces.

52.-57. (canceled)

58. The device of claim 1, wherein the tubes are microfluidic channels in a microfluidic chip.

59. The device of claim 1, wherein the at least one tubes are made from a material selected from the group consisting of polytetrafluoroethylene (PTFE) plastic, glass, polyethylene, polystyrene, polypropylene, PDMS, vinyl, and combinations thereof.

59.-62. (canceled)

63. The device of claim 1, wherein the hydrophobic fluid is selected from the group consisting of natural oil, plant-based oil, mineral oil, silicone oil, fluorinated oil, and combinations thereof.

63.-87. (canceled)

88. The device of claim 1, further comprising, in the at least one tubes, multiple or single microbial cells, plant cells, mammalian cells, virus particles, or combinations thereof.

88.-97. (canceled)

98. A process for making a partition in a tube, comprising the following steps in the following order:
a) providing a tube;
b) filling the tube with a hydrophobic solution; and
c) filling the tube with a hydrophilic solution.

99.-109. (canceled)

110. A method of using the device of claim 1, comprising performing a reaction in the tube;
wherein the reaction is selected from the group consisting of chemical, biological, biochemical, microbiological, immunological, or combinations thereof.

111. The method of claim 110, wherein the reaction in the tube is a gel polymerization, DNA or RNA amplification analysis, an antibody or aptamer library screening, or an antibody or aptamer binding assay.

112. (canceled)

113. (canceled)

114. A method of using the device of claim 1, comprising thermal cycling the device.

115. (canceled)

116. A method of using the device of claim 1, comprising recovering the hydrophobic fluid for secondary uses.

117. (canceled)

118. (canceled)

119. (canceled)

120. (canceled)

121. (canceled)
